(19) United States
(12) Patent Application Publication
(10) Pub. No.: US 2006/0177086 A1
(43) Pub. Date: Aug. 10, 2006

(54) Tubular, flexible wireless communication device

(76) Inventors: Ryan P. Rye, Lawrenceville, GA (US); David W. Larmour, Suwanee, GA (US); Robert N. Stanford, Flowery Branch, GA (US)

Correspondence Address: MOTOROLA, INC.;LAW DEPARTMENT, 600 NORTH U.S. HIGHWAY 45, AS437, LIBERTYVILLE, IL, 60048, US

(21) Appl. No.: 11/053,690

(22) Filed: Feb. 8, 2005

(51) Int. Cl. H04R 25/00

(52) U.S. Cl. 381/370; 351/123; 381/327

(57) ABSTRACT

This invention is a wireless communication device, for example a hands-free speakerphone accessory for a mobile telephone, that includes a pair of flexible elongated tubular members capable of attaching to the stems of eyeglasses. When the apertures or lumens in the flexible elongated tubes are attached to the stems of eyewear, the wireless communication device acts both as a wireless communication device and as an eyewear retainer. An adjustable clasp member and second clasp member mounted on the flexible tubular members allow the wireless communication device to form a closed loop, so as to be mounted on a user's neck, or other object, like a sun visor or steering wheel of an automobile. In one embodiment, at least one loudspeaker is coupled to one of the tubular members, while a low-profile microphone is coupled to the other tubular member.

### BACKGROUND

1. Technical Field

This invention relates generally to wireless accessories for portable electronic devices, and more specifically to a wireless speaker phone accessory for two-way communication devices that may be used either in conjunction with eyewear or as a stand-alone device.

2. Background Art

There was a time when portable electronic devices, like mobile telephones for example, had a very limited feature set. For example, early mobile telephones, which were the size of a football and were carried in a bag, were capable of only making and receiving telephone calls. With the many advances in technology however, today's modern mobile telephones have greatly expanded functionality and feature sets. For example, the V551 manufactured by Motorola is capable not only of making and receiving calls, but can also take photographs, shoot video clips and transmit or receive data from the World Wide Web. Additionally, the V551 is equipped with wireless Bluetooth technology that enables the phone itself to wirelessly communicate with other local devices like speakerphone modules, computers and headsets.

All of this new technology is advantageous because many cities and municipalities have begun to pass ordinances restricting the use of certain devices, like mobile telephones, when driving. For example, §588.03 of the Westchester County Code in New York states, “No person shall utilize a cellular phone while operating a motor vehicle on any public street or public highway within the county of Westchester.” Such ordinances generally include exceptions, however, for mobile devices that are equipped with “hands-free” functionality. By way of example, the Westchester Code states, “This law shall not be construed to prohibit a person operating a motor vehicle from utilizing a cellular phone equipped with a hands-free device.” Simply put, a “hands-free” device is any accessory that allows the user of a mobile phone to operate the phone without holding it in his or her hand.

Due in part to regulations like these, many manufacturers have begun to offer wireless hands-free accessories for mobile phone like speakerphone and headset modules. One example is the Quadrant speakerphone accessory manufactured by Motorola. This device communicates with a mobile phone without wires and converts the phone into a speakerphone by audibly broadcasting the call to the user. Rather than holding the phone against one's ear, one may simply put the phone in speakerphone mode and have the inward call broadcast throughout, for example, a vehicle.

The problem with these wireless hands-free devices is they are usually round in shape, and about the size of a small change purse. As such, they are not easily mountable in a vehicle. While they might be clipped on a visor with the aid of a holster, most people tend to take the speakerphone device and just throw them loosely in the passenger seat. When the speakerphone device is placed in such a position, any sudden turn or sudden stopping motion may cause the speakerphone device to fly off the seat and render any in-progress call inaudible.

There is thus a need for an improved wireless accessory for an electronic device that offers the user both an expanded number of mounting options and better audio performance.

### BRIEF DESCRIPTION OF THE DRAWINGS

FIG. 1 illustrates one preferred embodiment of a wireless communication device in accordance with the invention.

FIG. 2 illustrates another preferred embodiment of a wireless communication device in accordance with the invention.

FIG. 3 illustrates one preferred embodiment of a wireless communication device coupled to a conventional pair of eyeglasses.

FIG. 4 illustrates one preferred embodiment of a wireless communication device with an adjustable clasp member and second clasp in accordance with the invention, where the adjustable clasp member is coupled to the second clasp member so as to form a closed loop.

FIG. 5 illustrates one application of a wireless communication device in accordance with the invention wherein the wireless communication device is coupled to eyewear on a user's head.

FIG. 6 illustrates another application of a wireless communication device in accordance with the invention where the wireless communication device is coupled in a loop and placed about a user's neck.

FIG. 7 illustrates one application for a wireless communication device in accordance with the invention where the wireless communication device is coupled about the steering wheel of a car.

FIG. 8 illustrates one application of a wireless communication device in accordance with the invention where the wireless communication device is wrapped about a car door handle.

FIG. 9 illustrates a schematic block diagram 4 and electronic device in a wireless communication device in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention is a wireless communication device capable of coupling to conventional eyewear. Additionally, by coupling a clasp and clasp member together, the invention is capable of forming a closed loop so as to be mounted on a user's neck or other object like a car visor or rear view mirror.

In one embodiment, the wireless communication device has a pair of flexible members that extend from an electronic device like a speakerphone device or MP3 player. The flexible members are tubular in structure and include a hollow end. Each hollow end includes a lumen capable of receiving the stem portion of eyewear. The electronic device, which may be a radio, MP3 player, mobile telephone, mobile telephone headset, or wireless mobile telephone headset, is mounted between the two flexible members. A loud speaker, which is optionally retractable, is mechanically coupled to one of the flexible tubular members. In one preferred embodiment, the loudspeaker is capable of being inserted into a user's ear.

A low-profile microphone is coupled to one of the flexible tubular members as well. Where the communication device is a wireless mobile telephone headset, and where the stem portions of eyewear are inserted into the lumens of the flexible tubular members, the device can serve as a hands-free speaker phone accessory that both retains the eyewear on the user's head and offers hands-free operation of a mobile telephone. The fact that the low-profile microphone is coupled to one of the flexible tubular members, while the speaker is coupled to the other flexible tubular member, offers increased acoustic isolation between the speaker and microphone, thereby providing optimum audio performance. Additionally, this spacing reduces nuisance background noise, like echoes for example.

In addition to coupling to eyewear, the flexible tubular structure of this invention, along with a clasp member and second clasp, allows the flexible tubular members device to couple to each other so as to form a closed loop. In the closed loop form, the electronic device may be worn about a user's neck or may be placed, for example, on a car visor or wrapped about the steering wheel of an automobile. As such, the flexible tubular structure allows for multiple mounting positions and orientations. No separate mounting accessories are required, for the device is capable of acting as its holster, lanyard, or wrap.

The electronic device of the invention may include buttons that allow the user to operate the device. The electronic device may also include an integrated microphone and loudspeaker (in addition to the retractable earpiece speaker and low-profile microphone) that will allow the electronic device itself to be a stand-alone speakerphone. Since the invention is reversible, the speaker and microphone coupled to the flexible tubular members may be switched from side to side thereby accommodating the preference of the user. The flexible tubular structure of the wireless communication device is capable of housing other, additional components such as microphones, speakers, and or battery cells.

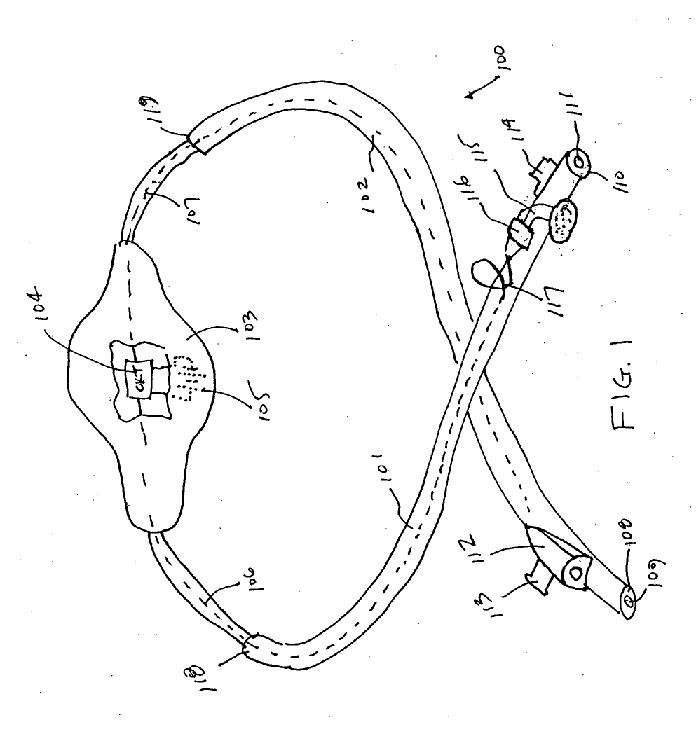

Turning now to FIG. 1, illustrated therein is one preferred embodiment of a wireless communication device 100 in accordance with the invention. For the purposes of discussion, the wireless communication device described herein will be a wireless speakerphone accessory for a mobile telephone, although the invention is not so limited. It will be clear to those of ordinary skill in the art having the benefit of this disclosure that the invention could also be extended to other devices, including radios, MP3 players, mobile telephones, and mobile telephone headsets. As a speakerphone accessory, the invention constitutes an aural excitation device, in that the speakerphone components of the communication device 100 may be audibly heard by the user.

A pair of flexible hollow, elongated tubes 101, 102, are coupled serially with an electronic device 103. Each tube 101, 102 has a first end 108, 110 and a second, distal end 118, 119. The first ends 108, 110 of each tube 101, 102 have a lumen or central bore 109, 111 that is sufficiently large as to slide over the end of an eyewear stem. The flexible elongated tubes 101, 102 may be manufactured from any of a variety of materials, including neoprene rubber or other stretchy, elastic materials. In this embodiment, the electronic device 103 is coupled to the second, distal ends 118, 119 of the flexible elongated tubes 101, 102.

Electronic circuitry 104 is disposed within the electronic device 103. The electronic circuitry 104 is optionally powered by a rechargeable battery 105 that may be disposed either within the electronic device 103 or within the central bores 109, 111 of either of the flexible elongated tubes 101, 102. Optional peripheral devices, including a low-profile microphone 112 and a earpiece speaker 115 may be coupled to the electronic device via wires or other conductors 106, 107 which pass from the circuitry 104 of the electronic device 103 through the flexible elongated tubes 101, 102.

For example, the earpiece speaker 115 may be mechanically coupled to the first end 110 of one of the flexible elongated tubes 101. The earpiece speaker 115 may be detachable from the end 110 of the flexible elongated tube 101 by way of a earpiece speaker holder 116 mounted atop the flexible elongated tube 101. Similarly, a low-profile microphone 112, may be mechanically coupled to the first end 108 of the other flexible elongated tube 102. Where both the low profile microphone 112 and earpiece speaker 115 are employed, placing the devices on opposing flexible elongated tubes 101, 102 increases the acoustical separation between the low profile microphone 112 and the earpiece speaker 115, thereby delivering improved audio performance.

An adjustable clasp member 114 may be coupled to one of the flexible elongated tubes 101. The adjustable clasp member 114 may be movable along the flexible elongated tube 101 such that the adjustable clasp member 114 may be moved to varying distances along the flexible elongated tube 101 towards and away from the electronic device 103. A second clasp member 113 may be coupled either to the other flexible elongated tube 102, or to the low-profile microphone 112 as is shown in FIG. 1.

The second clasp member 113 may be “clasped” to the adjustable clasp member 114 such that the electronic device 103, the elongated tube members 101, 102, the adjustable clasp member 114 and the second clasp member 113 form a closed loop. This closed loop configuration allows the wireless communication device 100 to be mounted in a variety of configurations. To accommodate this closed loop configuration, the adjustable clasp member 114 should be coupled to one of the flexible elongated tube members 101, while the second clasp member 113 is coupled to the flexible elongated tube member 102 to which the adjustable clasp member 114 is not coupled. Note that the earpiece speaker 115 may be optionally retractable, either by a spring loaded wheel or a springy loop of wire 117.

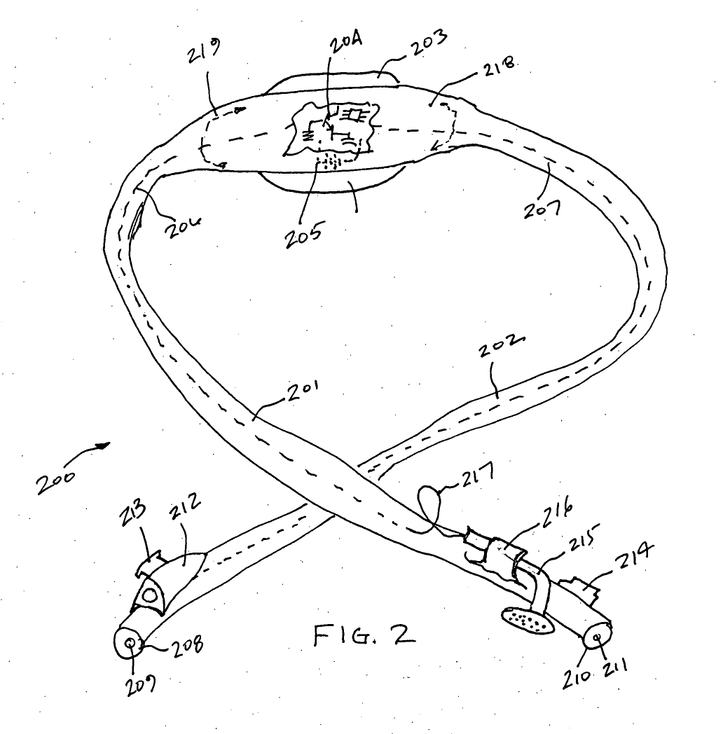

Turning now to FIG. 2 illustrated therein is an alternate embodiment of a wireless communication device 200 in accordance with the invention. The device 200 is similar to that shown in FIG. 1. The major difference between the device 200 of FIG. 2 when compared to the device 100 of FIG. 1 is that rather than having a pair of flexible elongated tube members, a single flexible member 218 has flexible elongated tubes 201, 202 extending therefrom. Similar to the device of FIG. 1, each flexible elongated tube 201, 202 include an end 208, 210 having an aperture or lumen 209, 211 therein that is suitable for accommodating the stem portion of eyeglasses or eyewear.

As in FIG. 1 an electronic device 203 is coupled to the flexible member 218. The electronic device 203 includes circuitry 204, for example circuitry associated with a wireless hands-free speakerphone accessory, that may be powered by a rechargeable battery 205. In this embodiment, the electronic device 203 is coupled to a central portion 219 of the flexible member 218.

As in FIG. 1, a loudspeaker 215 is mechanically coupled to either the first flexible elongated tube 201 or the second flexible elongated tube 202. As shown in FIG. 2, loudspeaker 215 is mechanically coupled to the first flexible elongated tube 201. The loudspeaker 215 is held in place by holder 216. As in FIG. 1, the loudspeaker 215 may be retractable either by a spring-loaded wheel or other similar device, including a springy coil of wire 217. The loudspeaker 215 is coupled to the electronic device 203 by a conductor or wire 206 which runs through the flexible elongated tube 201.

As in FIG. 1, a low profile microphone 212 is mechanically coupled to flexible elongated tube 202. For maximum acoustic isolation, the low-profile microphone 212 is coupled to the flexible elongated tube 202 to which the loudspeaker 215 is not coupled. The low-profile microphone 212 may be coupled to the electronic device 203 by way of a wire or other conductor 207 that runs through the flexible elongated tube 202.

The movable clasp 214 is coupled to either the first or second flexible elongated tubes 201, 202. As shown in FIG. 2, the movable clasp 214 is coupled to the first flexible elongated tube 201. A clasp connector 213 is coupled to the other flexible elongated tube 202, which is the flexible elongated tube to which the movable clasp 214 is not coupled. The clasp connector 213 may be mounted to the low-profile microphone 212 or may optionally be mounted directly to the second flexible elongated tube 202.

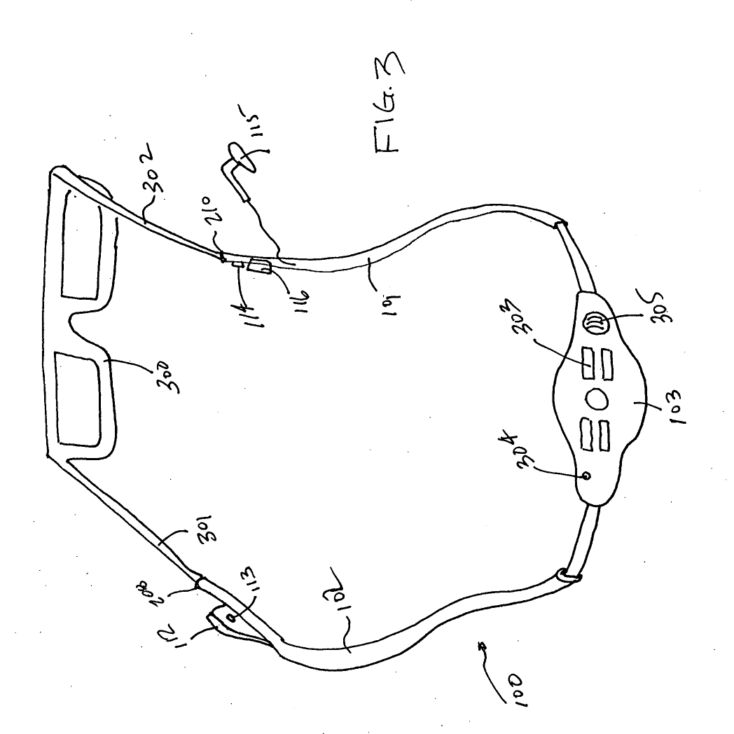

Turning now to FIG. 3, illustrated therein is one application of a wireless electronic device 100 in accordance with the invention. As shown in FIG. 3, the stem portions 301, 302 of eyewear 300, for example eyeglasses, safety glasses, sunglasses, or goggles, have been inserted into the hollow ends 208, 210 of the wireless communication device 100. As such, the wireless communication device 100 serves as an eyewear retention mechanism for the user.

In this configuration, the low profile microphone 112 picks up audible sounds from the user, while the earpiece speaker 115 provides aural excitations or sounds to the user. The optionally retractable earpiece loudspeaker 115 may be decoupled from the holder 116 and inserted into the user's ear. In this configuration, the adjustable clasp member 114 is, of course, decoupled from the second clasp member 113.

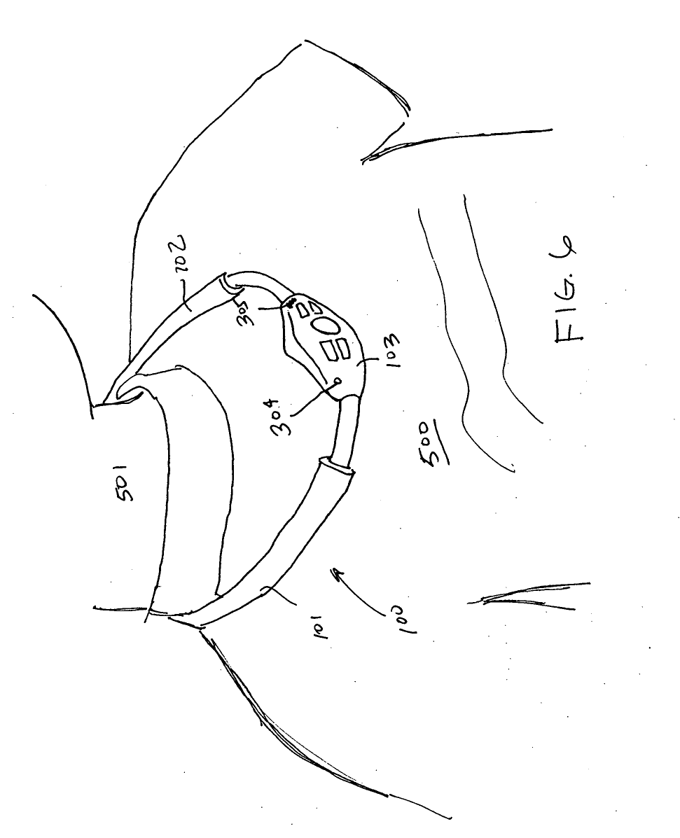

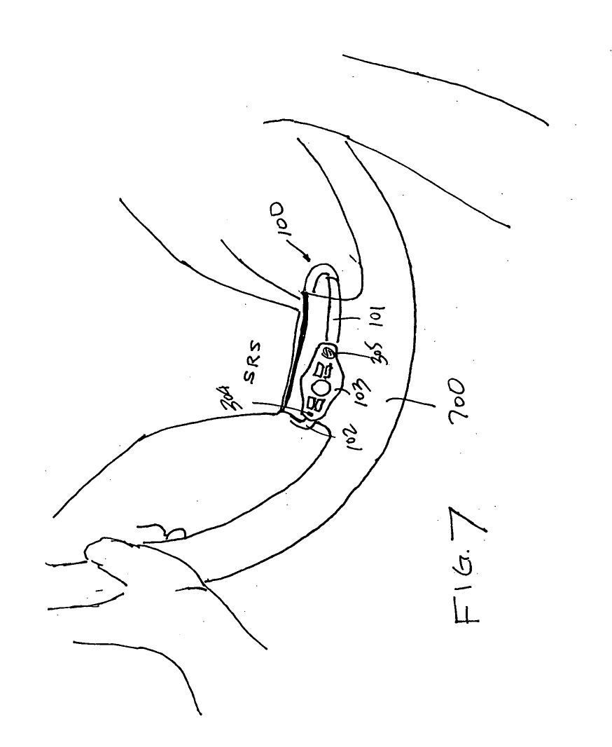

Note that the electronic device 103 may include buttons 303 for actuation or operation. Additionally, an embedded microphone 304 and embedded speaker 305 may also be incorporated into the electronic device 103. The embedded microphone 304 and embedded speaker 305 will prove useful when the electronic device 100 is adapted to other configurations as will be seen in the discussions of FIGS. 6 and 7.

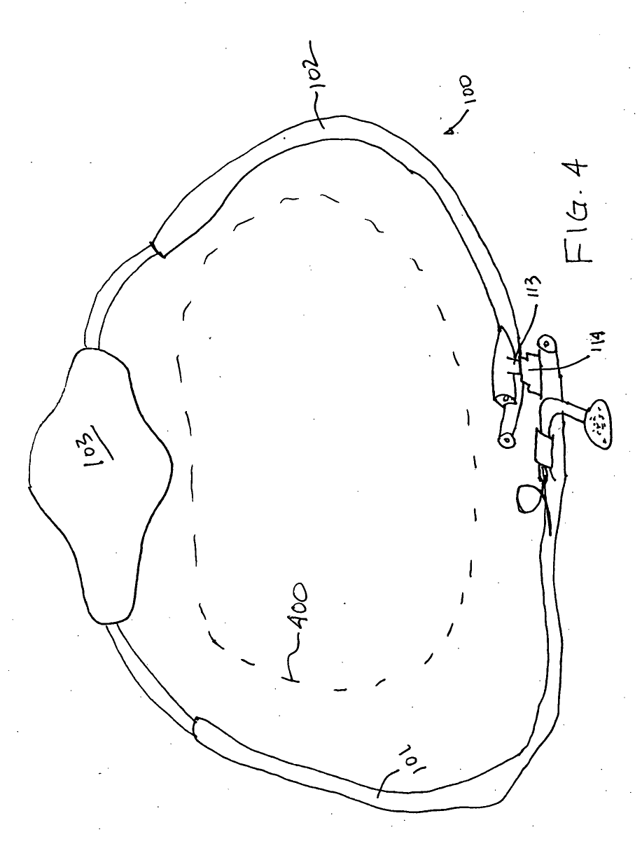

Turning now to FIG. 4, illustrated therein is an electronic device 100 in accordance with the invention that has been coupled in a closed loop configuration. In this configuration, the adjustable clasp member 114 has been coupled to the second clasp member 113 such that the electronic device 103, the flexible elongated tube members 101, 102, the adjustable clasp member 114 and the second clasp member 113 form a closed loop.

While in one configuration the electronic device 100 may be used as an eyewear retention device, as was discussed in FIG. 3, the closed-loop configuration of FIG. 4 allows the electronic device 100 to be adapted to many other environments. This will best be shown by example in the discussion of the following figures.

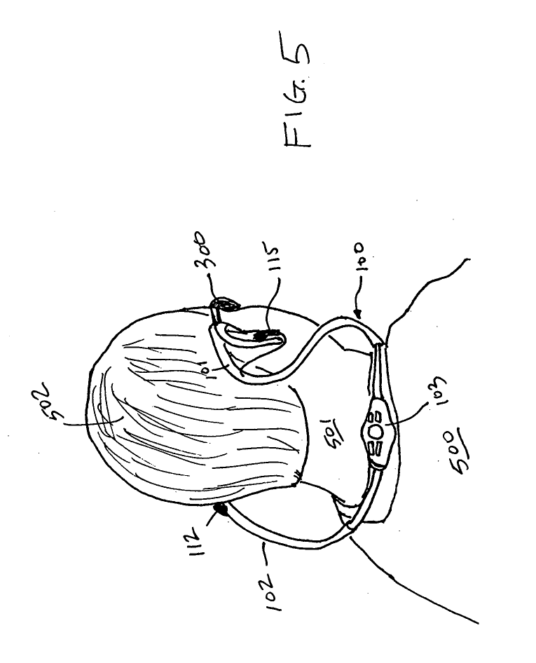

Turning now to FIG. 5, illustrated therein is one application of an electronic device 100 in accordance with the invention. In this application the electronic device 100 is being used as an eyewear retention device for a user 500. The hollow ends of the flexible elongated members 101, 102 have been coupled to the stem portions of eyewear 300. The earpiece speakerphone 115 has been inserted into the ear of the user 500 so that the user may hear the audible sounds being generated by the electronic device 103. The low-profile microphone 112, disposed on the other side of the user's head 502, is capable of picking up the user's voice or other nearby sounds.

Note that in this configuration, the electronic device 103, which is mounted serially between the flexible elongated tube members 101, 102, rests behind the user's neck 501, not adjacent to the user's ears. This behind the neck configuration, with the earpiece speaker 115 mounted in the user's ear, allows the volume of the aural excitations emanating from the electronic device 103 to be controlled, regardless of the electronic device's proximity to the user's ear.

Turning now to FIG. 6, illustrated therein is an alternate application for an electronic device 100 in accordance with the invention. In this configuration, the adjustable clasp member and second clasp (not shown) have been coupled together as was described in FIG. 4. In this configuration, as noted above, the electronic device 103, the flexible elongated tube members 101, 102, the adjustable clasp member, and second clasp form a closed loop. This closed loop is suitable for placement about the user's neck 501 such that the wireless communication device may be worn like a necklace.

In this configuration, the embedded microphone 304 and embedded speaker 305 become useful, as the earpiece speaker, and low-profile microphone discussed with reference to FIG. 5 are now behind the user's neck 501. As such, the embedded microphone 304 is capable of picking up the user's voice and other local sounds, while the embedded loudspeaker 305 broadcasts aural excitations from the electronic device 103 to the user 500.

Note that the application of FIG. 6 illustrates one of the numerous advantages that the electronic device 100 of this invention offers. While the application of FIG. 5 (as an eyewear retainer) is desirable for people who wear eyewear, not everyone wears eyewear. Some users, for example, may wear contact lenses or may not wear eyewear at all. For such users, the electronic wireless communication device 100 may be configured in the closed loop configuration of FIG. 6, with the need for any additional components, so as to better suit these “non-external-eye-wearing” users.

Turning now to FIG. 7 illustrated therein is yet another application of the electronic device. As the flexible elongated members 101, 102 of the electronic device 100 are both stretchy and flexible the electronic device 100 may be mounted on numerous objects, including the many objects found in an automobile. For example, in the application of FIG. 7, the electronic device has been wrapped about a steering wheel 700 of a car. As such, the embedded microphone 304 and embedded loudspeaker 305 of the electronic device 103 serve as a standalone speakerphone accessory for a mobile telephone that may be located anywhere in the car. This configuration is just one of many hands-free configurations to which the wireless communication device 100 of this invention may be adapted.

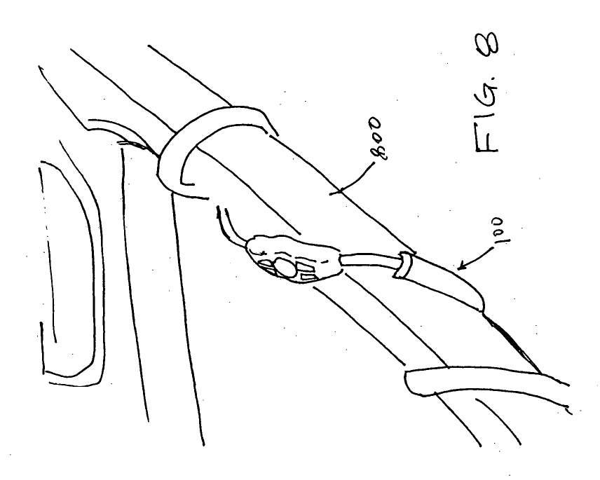

Turning now to FIG. 8 illustrated therein is yet another example of an application to which the wireless communication device 100 of this invention may be adapted. In the embodiment of FIG. 8, the electronic device 100 has been wrapped about the handle of a door 800 in a conventional automobile. As with FIG. 7, in this application, the electronic device 100 serves as a stand-alone wireless communication device which may link with a mobile telephone or other electronic device located anywhere within the vehicle.

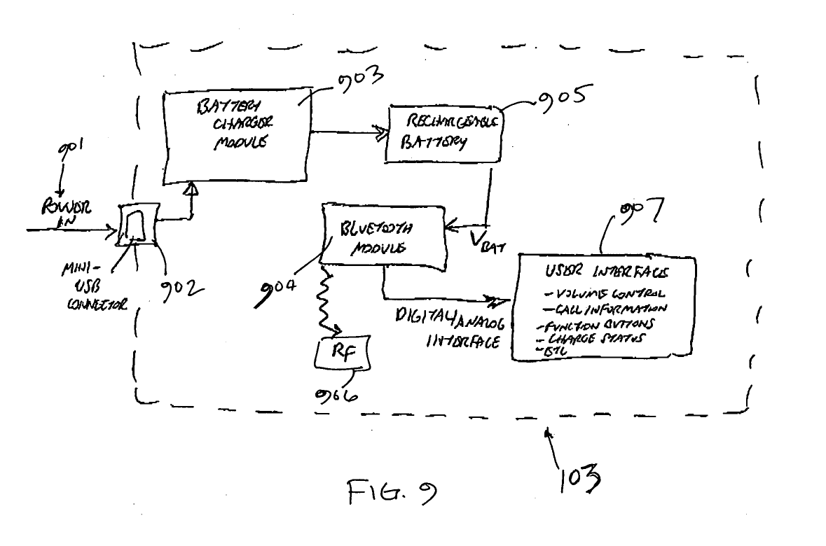

Turning now to FIG. 9, illustrated therein is a schematic block diagram for an electronic device 103 in accordance with the invention. The electronic device, as noted above, may be powered from a rechargeable battery 905 embedded within the electronic device 103. This rechargeable battery may have battery charging circuitry 903 coupled thereto to ensure proper charging of the rechargeable battery 905. The battery charging circuitry 903 may receive power from an external power connector 902 that may be selectively coupled to a power source 901.

The rechargeable battery 905 supplies power to a wireless communication module 904. The wireless communication module 904 may be any type of wireless communication module as is commonly known in the art. For example, the wireless communication module 904 may, for example, be a Bluetooth enabled or other type of local communication device. The wireless communication module 904 transmits and receives data through a radio frequency modulation circuitry 906 that may include an antenna, amplifiers and other transmission and receiving circuitry. Coupled to the wireless communication module 904 is a user interface 907 that may include, for example, volume control, call information, function buttons, charge status and fuel gauge indicators, and the like.

The electronic device of the present invention offers numerous advantages over the prior art. The advantages include the elimination of spurious background noises, including echoes, as the low-profile microphone and earpiece speakers are mounted on opposite sides of a user's head when the device is used as an eyewear retainer. Additionally, the wireless communication device of this invention is capable of mounting in many locations on a user's body, as well as to other objects, without any additional attachments. For example, as noted above, the wireless communication device may be used as an eyeglass retainer or may be mounted to any of a variety of objects including a steering wheel, a user's neck, a door handle, or other things like a car visor, rearview mirror, headrest or gear shift.

By comparison to the prior art, U.S. Pat. No. 6,091,832, entitled “Wearable Personal Audio Loop Apparatus,” describes a rigid, U-shaped plastic frame that includes certain audio components like loud speakers. The rigid frame also includes receptacles for eyeglass lenses such that the device can turn into a pair of sunglasses. However, the '832 patent has several limitations.

First, the rigid construction limits the number of ways that the device may attach to either a user or other objects. Additionally, the rigid construction may not comfortably fit users who just happen to have smaller or larger sized heads. Second, the '832 patent does not allow a user to wear his or her favorite eyewear, as the '832 patent dictates that custom, and therefore expensive, lenses must be inserted into the rigid plastic frame. By contrast, the wireless communication device of this invention may be attached to any pair of existing eyewear, thereby making it a universal eyewear retainer. Third, the rigid U-shape loop is not capable of attaching two other objects like the user's neck, a automobile steering wheel, sun visor, or door handle.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. An aural excitation device, comprising:
a. a pair of flexible hollow, elongated tubes, each tube having first end and a second, distal end, the first end having a central bore sufficiently large to slide over an end of an eyewear stem;
b. an electronic device coupled serially between each of the pair of flexible hollow, elongated tubes such that the electronic device is coupled to the second, distal ends of each of the pair of flexible hollow, elongated tubes;
c. at least one earpiece speaker, the at least one earpiece speaker being mechanically coupled to the first end of at least one of the flexible hollow, elongated tubes, the at least one earpiece speaker being electrically coupled to the electronic device by an electrical conductor passing through at least one of the flexible hollow, elongated tubes;
d. a low-profile microphone, the low-profile microphone being mechanically coupled to the first end of at least one of the flexible hollow, elongated tubes, the low-profile microphone being electrically coupled to the electronic device by an electrical conductor passing through at least one of the flexible hollow, elongated tubes; and
e. an adjustable clasp member coupled to at least one of the flexible hollow, elongated tubes, the adjustable clasp member being moveable along the at least one flexible hollow, elongated tubes.

2. The device of claim 1, wherein a second clasp member is coupled to the at least one of the flexible hollow, elongated tubes, the second clasp member being coupled to the flexible hollow, elongated tube to which the adjustable clasp member is not coupled.

3. The device of claim 2, wherein the electronic device is selected from the group consisting of radios, MP3 players, mobile telephones, mobile telephone headsets, wireless mobile telephone headsets.

4. The device of claim 3, wherein the earpiece speaker is retractable.

5. The device of claim 4, wherein the electronic device comprises an embedded loudspeaker.

6. The device of claim 5, wherein the electronic device comprises an embedded microphone.

7. The device of claim 3, wherein the electronic device comprises a rechargeable battery.

8. The device of claim 2, wherein when the adjustable clasp member is coupled to the second clasp member, the pair of flexible hollow, elongated tubes, the electronic device, the adjustable clasp member and the second clasp member forms a closed loop.

9. The device of claim 8, wherein both the adjustable clasp member and the second clasp member comprise half-snaps.

10. A flexible wireless communication device, comprising:
a. a flexible member having a central portion and a pair of flexible tubular members extending therefrom, the pair of flexible tubular members comprising a first and a second flexible tubular member, the first tubular member having a first hollow end, the second tubular member having a second hollow end;
b. an electronic device coupled to the central portion;
c. at least one loudspeaker mechanically coupled to a tubular member selected from the group consisting of the first flexible tubular member and the second flexible tubular member, wherein the at least one loudspeaker is electrically coupled to the electronic device;
d. at least one low-profile microphone mechanically coupled to a tubular member selected from the group consisting of the first flexible tubular member and the second flexible tubular member, wherein the at least one low-profile microphone is electrically coupled to the electronic device;
e. an moveable clasp coupled to a flexible tubular member selected from the group consisting of the first flexible tubular member and the second flexible tubular member; and
f. a clasp connector coupled to a flexible tubular member to which the moveable clasp is not coupled.

11. The device of claim 10, wherein the first hollow end and the second hollow end each comprises a lumen capable of receiving the stem portion of eyewear.

12. The device of claim 11, wherein the at least one loudspeaker is retractable.

13. The device of claim 12, wherein both the electrical coupling between the at least one loudspeaker and the electronic device and the electrical coupling between the at least one low-profile microphone comprise electrical conductors running through the first flexible tubular member and the second flexible tubular member.

14. The device of claim 13, wherein the electronic device is selected from the group consisting of radios, MP3 players, mobile telephones, mobile telephone headsets, wireless mobile telephone headsets.

15. The device of claim 14, wherein the electronic device comprises a wireless mobile telephone headset.

16. The device of claim 15, wherein the electronic device comprises an embedded loudspeaker and an embedded microphone.

17. The device of claim 16, wherein the electronic device comprises a five-button user interface.

18. The device of claim 15, wherein the electronic device further comprises a rechargeable battery.

19. The device of claim 14, wherein the moveable clasp comprises a female snap, further wherein the clasp connector comprises a male snap.

20. The device of claim 14, wherein when the moveable clasp is coupled to the clasp connector, the flexible member, the moveable clasp and the clasp connector form a closed loop.
